(19) United States
(12) Patent Application Publication
(10) Pub. No.: US 2023/0253911 A1
(43) Pub. Date: Aug. 10, 2023

(54) PULSED ELECTRIC MACHINE CONTROL

(71) Applicant: Tula eTechnology, Inc., San Jose, CA (US)

(72) Inventor: Md Zakirul ISLAM, San Jose, CA (US)

(21) Appl. No.: 18/165,100

(22) Filed: Feb. 6, 2023

Related U.S. Application Data
(60) Provisional application No. 63/307,501, filed on Feb. 7, 2022.

(51) Int. Cl. H02P 27/08; H02P 23/14

(52) U.S. Cl. CPC H02P 27/085; H02P 23/14

(57) ABSTRACT

An electric machine controller is described that is arranged to direct a power converter to cause pulsed operation of the electric machine in selected operational ranges to deliver a desired output. The pulsed operation of the electric machine causes the output of the electric machine to alternate between a first torque level, a second torque level, and an intermediate torque level range providing a shaped pulse pattern. The second torque level is lower than the first torque level and the intermediate torque level range is between the first torque level and the second torque level. The first torque level, second torque level, intermediate torque level range, and shaped pulse pattern are selected to provide a third torque level output such that the system has a higher energy conversion efficiency during the pulsed operation of the electric machine than the system would have when operated at a third torque level that would be required to drive the electric machine in a continuous manner to deliver the third torque level output, wherein the intermediate torque level range is a range of less than 5 Nm and wherein the intermediate torque level range is provided for at least 1 millisecond.

### CROSS-REFERENCE TO RELATED APPLICATION

This application claims the benefit of priority of U.S. Application No. 63/307,501, filed Feb. 7, 2022, which is incorporated herein by reference for all purposes.

### BACKGROUND

The present application relates generally to electric machine control. More specifically, control schemes and controller designs are described that pulse the operation of an electric machine during selected operating conditions to facilitate operating the electric machine in a more energy efficient manner.

### SUMMARY

An electric machine controller and electric machine control methods are described that are arranged to direct a power converter to cause pulsed operation of the electric machine in selected operational ranges to deliver a desired output. The pulsed operation of the electric machine causes the output of the electric machine to alternate between a first torque level, a second torque level, and an intermediate torque level range providing a shaped pulse pattern. The second torque level is lower than the first torque level and the intermediate torque level range is between the first torque level and the second torque level. The first torque level, second torque level, and intermediate torque level range and shaped pulse pattern are selected to provide an overall average system output having a higher energy conversion efficiency during the pulsed operation of the electric machine than the system would have when operated at a third torque level that would be required to drive the electric machine in a continuous manner to deliver the same average output, wherein the intermediate torque level range is a range of less than 5 Nm and wherein the intermediate torque level range is provided for at least 1 millisecond. In some embodiments, the intermediate torque level range is a range of less than 5 Nm and wherein the intermediate torque level range is provided for at least 0.2 milliseconds.

In another aspect, an electric machine controller and electric machine control methods are described that are arranged to direct a power converter to cause pulsed operation of the electric machine in selected operational ranges to deliver a desired output. The pulsed operation of the electric machine causes the output of the electric machine to alternate between a first torque level, a second torque level, and an intermediate torque level range providing a pulse train pattern. The second torque level is lower than the first torque level and the intermediate torque level range is between the first torque level and the second torque level. The first torque level, second torque level, and intermediate torque level range and pulse train pattern are selected to provide an overall average system output having a higher energy conversion efficiency during the pulsed operation of the electric machine than the system would have when operated at a third torque level that would be required to drive the electric machine in a continuous manner to deliver the same average output, wherein the intermediate torque level range is a range of less than 5 Nm and wherein the intermediate torque level range is provided for at least 1 millisecond.

In another aspect, an electric machine controller and electric machine control methods are described that are arranged to direct a power converter to cause pulsed operation of the electric machine in selected operational ranges to deliver a desired output. The pulsed operation of the electric machine causes the output of the electric machine to alternate between a first torque level, a second torque level, and an intermediate torque level providing a shaped pulse pattern. The second torque level is lower than the first torque level and the intermediate torque level is between the first torque level and the second torque level. The first torque level, second torque level, intermediate torque level, and shaped pulse pattern are selected to provide an overall average system output having a higher energy conversion efficiency during the pulsed operation of the electric machine than the system would have when operated at a third torque level that would be required to drive the electric machine in a continuous manner to deliver the same average output.

These and other features of the present disclosure will be described in more detail below in the detailed description and in conjunction with the following figures.

### BRIEF DESCRIPTION OF THE DRAWINGS

The invention and the advantages thereof, may best be understood by reference to the following description taken in conjunction with the accompanying drawings in which:

FIG. 1 is a representative Torque/Speed/Efficiency graph illustrating the energy conversion efficiency of a representative electric motor under different operating conditions.

FIG. 2 is a graph illustrating a pulsed drive signal for an electric machine.

FIG. 3 illustrates an example of a shaped pulse pattern used in an embodiment.

FIG. 4 illustrates an example of another shaped pulse pattern used in another embodiment.

FIG. 5 is a functional block diagram that diagrammatically illustrates an electric machine controller used in some embodiments.

FIG. 6 is a flow chart illustrating a motor control scheme in accordance with some embodiments.

FIG. 7A is a diagrammatic representation of a continuous three-phase AC drive signal waveform.

FIG. 7B is a diagrammatic representation of a pulsed three-phase AC waveform having a 20% duty cycle that represents the same average power as the continuous waveform of FIG. 7A.

FIG. 7C illustrates an example of a pulsed three-phase AC waveform used to provide the shaped pulse pattern shown in FIG. 3.

FIG. 8 illustrates an example of a shaped pulse pattern used in another embodiment.

FIG. 9 illustrates an example of a shaped pulse pattern used in some embodiments.

FIGS. 10A-C illustrate shaped pulse patterns used in some embodiments.

In the drawings, like reference numerals are sometimes used to designate like structural elements. It should also be appreciated that the depictions in the figures are diagrammatic and not to scale.

### DETAILED DESCRIPTION

The present application relates to pulsed control of a wide variety of electric machines (e.g., electric motors and generators) that would otherwise be operated in a continuous manner. Pulsed electric machine control is described in U.S. Pat. Nos. 10,742,155 (P200B); 10,944,352(P201); 11,077,759 (P208C1); 11,088,644 (P207C1); 11,133,767 (P204X1); 11,167,648 (P205); and U.S. Pat. Application No. 16/912,313 filed Jun. 25, 2020 (P200C). Each of the foregoing applications is incorporated herein by reference in its entirety. As described in the incorporated applications, pulsed control of an electric machine offers the advantage of improving the operational energy conversion efficiency of the machine

The phrase “electric machine” as used herein is intended to be broadly construed to mean both electric motors and generators. Electric motors and generators are structurally very similar. When an electric machine is operating as a motor, it converts electrical energy into mechanical energy. When operating as a generator, the electric machine converts mechanical energy into electrical energy.

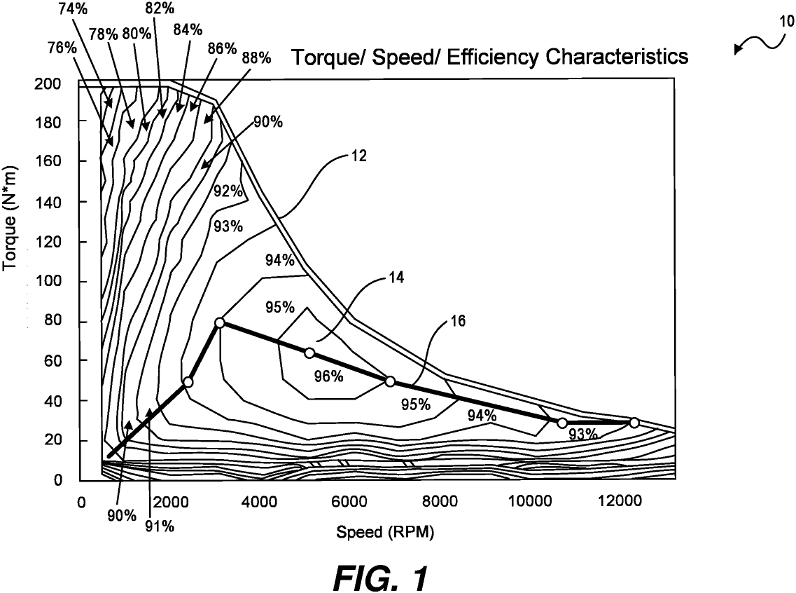

Electric motors and generators are used in a very wide variety of applications and under a wide variety of operating conditions. In general, many modern electric machines have relatively high energy conversion efficiencies, however, the energy conversion efficiency of most electric machines can vary considerably based on their operational load. Many applications require that the electric machine operates under a wide variety of different operating load conditions, which means that the electric machine often does not operate as efficiently as it is capable of. The nature of this problem is illustrated in FIG. 1, which is a motor efficiency map 10 that diagrammatically shows the efficiency of a representative motor under different operating conditions. More specifically, the figure plots the energy conversion efficiency of the motor as a function of motor speed (the X-axis) and torque generated (the Y-axis).

As can be seen in FIG. 1, the illustrated motor is generally most efficient when it is operating within a particular speed range and generating torque within a defined range 12. For the particular motor shown, the most efficient region of its operating range is the operating region labeled 14 which is generally in the range of 4500-6000 RPM with a torque output in the range of about 40-70 Nm where its energy conversion efficiency is approximately 96%. The region 14 is sometimes referred to herein as the “sweet spot”, which is simply the motor’s most efficient operating region.

As can be seen in FIG. 1, at any particular motor speed, there will be a corresponding most efficient output torque which is diagrammatically illustrated by maximum efficiency curve 16. For any given motor speed, the motor’s efficiency tends to drop off somewhat when the motor’s load is higher or lower than the most efficient load. In some regions, the motor’s efficiency tends to drop relatively quickly, for example when the torque output falls below about 30 Nm in the illustrated motor.

If the operating conditions could be controlled so that the motor is almost always operated at or near its sweet spot, the energy conversion efficiency of the motor would be quite good. However, many applications require that the motor operates over a wide variety of load conditions with widely varying torque requirements and widely varying motor speeds. One such application that is easy to visualize is automotive and other vehicle or mobility applications where the motor speed may vary between zero when the vehicle is stopped to a relatively high RPM when cruising at highway speeds. The torque requirements may also vary widely at any of those speeds based on factors such as whether the vehicle is accelerating or decelerating, going uphill, downhill, going on relatively flat terrain, etc., the weight of the vehicle, and many other factors. Of course, motors used in other applications may be subjected to a wide variety of operating conditions as well.

Although the energy conversion efficiency of conventional electric machines is generally good, there are continuing efforts to further improve energy conversion efficiencies over broader ranges of operating conditions. The present disclosure relates generally to pulsed control of electric machines (e.g., electric motors and generators) that would otherwise be operated in a continuous manner to improve the energy conversion efficiency of the electric machine when operating conditions warrant. More specifically, under selected operating conditions, an electric machine is intermittently driven (pulsed) at more efficient energy conversion operating levels to deliver a desired average torque more energy efficiently than would be attained by traditional continuous motor control.

Many types of electrical machines, including mechanically commutated machines, electronically commutated machines, externally commutated asynchronous machines, and externally commutated synchronous machines are traditionally driven by a continuous, albeit potentially varying, drive current when the machine is used as a motor to deliver a desired torque output. The drive current is frequently controlled by controlling the output voltage of a power converter (e.g., an inverter) which serves as the voltage input to the motor. Conversely, the power output of many types of generators is controlled by controlling the strength of a magnetic field - which may, for example, be accomplished by controlling an excitation current supplied to rotor coils by an exciter. (The exciter may be part of a rectifier or other suitable component). Regardless of the type of machine, the drive current for a motor, or the current output by a generator, tends to be continuous. The continuous drive current output may be a continuous direct current (DC) or continuous alternating current (AC).

With pulsed control, the output of the machine is intelligently and intermittently modulated between different torque levels in a manner that: (1) meets operational demands, while (2) improving overall efficiency. Stated differently, under selected operating conditions, the electric machine is intermittently driven at more efficient energy conversion operating levels than would be available if the electric machine is driven in a continuous and steady manner to deliver a desired output.

As previously discussed, FIG. 1 illustrates the energy conversion efficiency of a representative motor. The map illustrated in FIG. 1 is the efficiency map for an internal permanent magnet synchronous motor used in a 2010 Toyota Prius. It should be understood that this map is merely illustrative. Similar efficiency maps can be generated for just about any electric machine although the characteristics of the map will vary with the machine that is characterized.

As can be seen in FIG. 1, at any particular motor speed, there will be a corresponding most efficient output torque which is diagrammatically illustrated by maximum efficiency curve 16. From a conceptual standpoint, when the desired motor torque is below the most efficient output torque for the current motor speed, the overall efficiency of the motor can be improved by pulsing the motor. Conversely, when the desired motor torque is at or above the maximum efficiency curve 16, the motor may be operated in a conventional (continuous/non-pulsed) manner to deliver the desired torque.

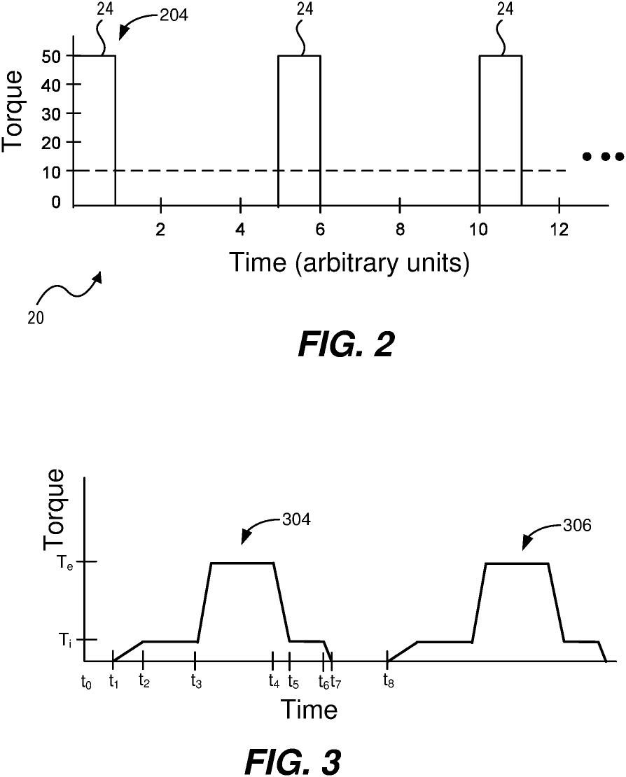

FIG. 2 illustrates an example of pulsed motor operation. This example is described in U.S. Pat. No. 10,742,155, issued Aug. 11, 2020, to Adya S. Tripathi, which is incorporated by reference for all purposes. In this particular example, the desired motor torque is 10 Nm, but the most efficient torque output for the current operating motor speed is 50 Nm. Conceptually, the motor can be driven to deliver a net torque of 10 Nm by causing the motor to deliver 50 Nm (labeled 24) of torque for 20% of the time and then delivering no (zero) torque for the remaining 80% of the time. Since the motor operates more efficiently when it is delivering 50 Nm than when it delivers 10 Nm, the motor’s overall efficiency can be improved by pulsing the motor’s operation in the described manner. In the example illustrated in FIG. 2, the motor produces a torque pulse pattern 204 to provide a motor output of 50 Nm (labeled 24) for a period of 1 time unit out of every 5 time units, and then the motor is controlled to produce zero torque during the intervening 4 time units.

As long as the desired motor output does not exceed 50 Nm, the desired motor output can theoretically be met merely by changing the duty cycle of the motor operating at 50 Nm. For example, if the desired motor output changes to 20 Nm, the duty cycle of the motor operating at 50 Nm can be increased to 40%; if the desired motor output changes to 40 Nm, the duty cycle can be increased to 80%; if the desired motor output changes to 5 Nm, the duty cycle can be reduced to 10% and so on. More generally, pulsing the motor can potentially be used advantageously any time that the desired motor torque falls below the maximum efficiency curve 16.

The scale of the time units actually used may vary widely based on the size, nature, and design needs of any particular system. In practice, when the motor is switched from the “torque on” to “zero torque” states relatively rapidly to achieve the designated duty cycle, the fact that the motor is actually being switched back and forth between these states may not materially degrade the motor’s performance from an operational standpoint. In some embodiments, the scale of the periods for each on/off cycle is expected to be on the order of 100 µsec to 0.10 seconds (i.e., pulsing at a frequency in the range of 10 to 10,000 Hz), for example in the range of 20 to 1000 Hz, or 20 to 100 Hz as will be discussed in more detail below.

The zero torque portions of the pulse cycle might conceptually be viewed as shutting the motor off – although in many cases the motor may not actually be shut off during those periods or may be shut off for only portions of the “zero torque” intervals.

In various embodiments, the pulsed motor operations provide shaped pulses to provide either a first torque level at a higher efficiency torque level that provides a higher efficiency torque, a second torque level at a zero torque level, and at least one intermediate torque level range between the first torque level and the second torque level. The addition of the intermediate torque level range helps to smoothen the radial force variation and indirectly increases the torque modulation frequency. An increase in the torque modulation frequency may be used to shift the torque frequency into a frequency range with lower noise vibration hardness (NVH). In addition, by smoothening the radial and tangential force transition, NVH is reduced, and wear and tear on gear teeth is also reduced.

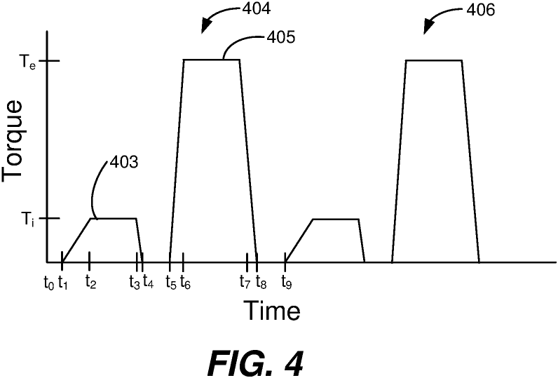

FIG. 3 illustrates an example of a shaped pulse pattern 304 used in an embodiment. In this embodiment, from time t₀ to t₁, zero torque level pulses are applied to the motor. In this example, the zero torque level pulses provide no power or pulses. A shaped pulse pattern 304 is then applied. In the torque pattern from time t₁ to t₂, the torque level is ramped from zero to an intermediate power or torque level range, which in this embodiment is a single intermediate power or torque level value Tᵢ. From time t₂ to t₃, the torque level is held at the intermediate torque level value Tᵢ, providing a first intermediate torque level. From time t₃ to t₄, the torque is ramped to and held at a higher efficiency torque level Tₑ, providing a higher efficiency torque level step. From time t₄ to t₅, the torque level is ramped down to the intermediate torque level value Tᵢ. From time t₅ to t₆, the torque level is held at the intermediate torque level value Tᵢ, providing a second intermediate torque level range step. From time t₆ to t₇, the torque level is ramped down to zero. The shaped pulse pattern 304 is completed. From time t₇ to t₈, the torque level is kept at zero, providing a zero torque level step. A new shaped pulse pattern 306 begins at time t₈. In this embodiment for a given desired torque output, the shaped pulse pattern 304 and the new shaped pulse pattern 306 have the same shape and provide a set duty cycle. The first intermediate torque level range step and the higher efficiency torque level step are repeated with the same frequency and out of phase from each other. To change the desired torque output, the shape of the shaped pulse pattern and the duty cycle may be changed. In order to control output torque while minimizing NVH, the duty cycle, the intermediate torque level range, the higher efficiency torque level, and the times of the various components of the shaped pulse pattern may be used as control parameters. In some embodiments, the intermediate torque level value Tᵢ is provided for at least a period of 1 millisecond.

In this embodiment in a shaped pulse pattern, the torque is stepped up to the intermediate torque level range for a period of time before the torque is further stepped up to the higher efficiency torque without stepping down the torque to a zero torque between the application of the intermediate torque level range and the higher efficiency torque level. In addition, in this embodiment, the torque is stepped down from the higher efficiency torque level to the intermediate torque level range for a period of time before the torque is further stepped down to the zero torque level. The first (higher efficiency) torque level, second torque level, and intermediate torque level range and shaped pulse pattern are selected to provide an overall average system output having a higher energy conversion efficiency during the pulsed operation of the electric machine than the electric machine would have when operated at a third torque level that would be required to drive the electric machine in a continuous manner to deliver the same overall average system output.

Providing a shaped pulse pattern with an intermediate torque level range for a period of time may be used to reduce NVH in various ways. For example, the use of an intermediate torque step would provide less jerk than stepping directly from a zero torque level to the higher efficiency torque level. In addition, a change in the frequency of vibration due to changes in torque may be modulated. Vibrations caused by changes in torque in the shaped pulse pattern 306 may be caused by the transition from the zero torque level to the intermediate torque level range and by the transition from the intermediate torque level range to the higher efficiency torque level and the transition from the higher efficiency torque level to the intermediate torque level range and by the transition from the intermediate torque level range to the zero torque level. As a result, the shaped pulse pattern 306 may cause four vibrations per pulse. In comparison, the torque pulse pattern 202 would cause two vibrations per pulse. Therefore, the shaped pulse pattern 306 may be able to double the frequency of vibrations. Increasing the frequency of vibrations can be used to increase the frequency of vibrations to a range that has a lower NVH

In some embodiments, a lookup table is used to determine the shaped pulse pattern and duty cycle. In an example, a requested torque output may be specified, and the lookup table may use the requested torque output and machine speed as indices to look up the desired torque pulse pattern and duty cycle. The shaped pulse pattern and duty cycle provide the desired torque output and speed and minimum noise and vibration level. In an embodiment, for most desired torque and speed combinations a torque pulse pattern and duty cycle as shown in FIG. 2 is sufficient. However, for some torque and speed combinations, a torque pulse pattern and duty cycle, as shown in FIG. 2 provides more vibration or noise than desired. In such cases, a more shaped pulse pattern and duty cycle, as shown in FIG. 3 would then be specified in the lookup table.

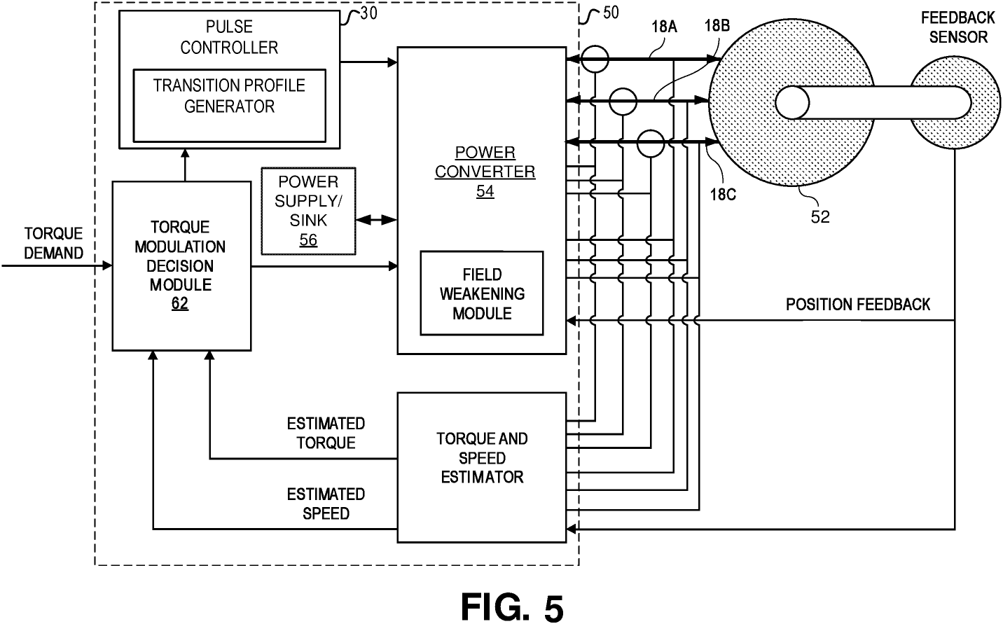

FIG. 4 illustrates an example of a torque pulse train pattern 404 used in another embodiment. In this embodiment, from time t₀ to t₁, zero torque level pulses are applied to the motor. In this example, the zero torque level pulses provide no power or pulses. A torque pulse train pattern 404 is then applied. In this example, the torque pulse train pattern 404 comprises an intermediate torque level pulse 403 and a higher efficiency pulse 405. In the torque pulse train pattern 404 from time t₁ to t₂, the torque level is ramped from zero to an intermediate power or torque level Tᵢ. From time t₂ to t₃, the torque level is held at the intermediate torque level range Tᵢ, providing an intermediate torque level step. From time t₃ to t₄, the torque is ramped down to a zero torque level. From time t₄ to t₅, the torque level is maintained at the zero torque level, providing a first zero torque level step. From time t₅ to t₆, the torque level is ramped up to a higher efficiency torque Tₑ. From time t₆ to t₇, the torque level is maintained at the higher efficiency torque Tₑ, providing a higher efficiency torque level step. From time t₇ to t₈, the torque level is ramped down to the zero torque level. A torque pulse train pattern 404 is completed. From time t₈ to t₉, the torque level is kept at zero, providing a second zero torque level step, where a new torque pulse train pattern 406 begins at time t₉. The combination of the intermediate torque level pulse 403 at the intermediate torque level range Tᵢ and the higher efficiency pulse 405 at the higher efficiency torque level Tₑ, may be considered a torque pulse train pattern 404. The series of intermediate pulses at the intermediate torque level Tᵢ and the series of higher efficiency pulses at the maximum torque level Tₑ may be considered two separate series of torque pulse patterns out of phase with the same frequency. In essence, one series of pulses is shifted in phase with respect to the other series of pulses. The phase difference between the two different series of pulses, the pulse widths, and pulse amplitudes provide additional degrees of freedom for reducing NVH.

In this embodiment, the pulse train pattern comprising the first torque level pulse for a first period of time, the second torque level for a second period of time, the intermediate torque level range pulse for a third period of time, and the second torque level for a fourth period of time, wherein the second period of time is between the first period of time and the third period of time, and the fourth period of time is after the third period of time. In such an embodiment, a pulse train pattern could be in the order of the third period of time, then the fourth period of time, then the first period of time, and then the second period of time. In other embodiments, the pulse train pattern may also include additional pulses. In some embodiments, the additional pulses may be at the first torque level or the second torque level. In various embodiments, the additional torque levels may be separated by periods of the second torque level. In some embodiments, at least one of the additional pulses is at a torque level that is different from the first torque level, the second torque level, and the intermediate torque level range. In the various embodiment, the pulse train pattern provides an overall average system output having a higher energy conversion efficiency during the pulsed operation of the electric machine than the electric machine would have when operated at a third torque level that would be required to drive the electric machine in a continuous manner to deliver the same overall average system output.

In some embodiments, the intermediate torque level is less than 50% of the higher efficiency torque level. In some embodiments, the intermediate torque level is less than 25% of the higher efficiency torque level. In some embodiments, the rate of rise to the intermediate torque level is lower than the rate of rise to the higher efficiency torque level, as shown in the examples in FIGS. 3 and 4. In some embodiments, the higher efficiency torque level is at least 80% of the maximum torque efficiency. In some embodiments, the higher efficiency torque is at least 95% of the maximum torque efficiency. The higher efficiency torque level is a higher efficiency torque level than the intermediate torque level and the zero torque level.

In some embodiments for shaped pulse patterns shown in FIG. 3, the time period from t₁ to t₃ is about equal to the time period from t₃ to t₅, which is about equal to the time period from t₅ to t₇, which is about equal to the time period from t₇ to t₈. By making these time periods equal each pulse period is divided up into four equal periods. In other words, the frequency of changing from one state to another is four times the frequency of each shaped pulse pattern 304. In some embodiments, the time period from t₅ to t₇ is shortened and the time from t₇ to t₈ is increased so that the time from t₁ to t₅ is about equal to the time from t₅ to t₈. These equal time periods help reduce NVH. Having the time period from t₁ to t₃ about equal to the time period from t₃ to t₅, which is about equal to the time period from t₅ to t₇, reduced NVH.

In some embodiments, the period from t₁ to t₃ is increased while the period from t₃ to t₅ is decreased and Tₑ is increased. The amount of increase of Tₑ is sufficient so that the area of the pulse is not changed by increasing the period from t₁ to t₃ while decreasing the period from t₃ to t₅.

In some embodiments, for a given desired output torque and a given duty cycle, the area of a torque pulse pattern 204 in FIG. 2 would be about equal to an area of a shaped pulse pattern 304 in FIG. 3 or an area of a torque pulse train pattern 404 in FIG. 4. The use of an intermediate torque level range is offset by increasing the higher efficiency torque level and/or the width of the pulse while decreasing the amount of time at the zero torque level in order to keep the area about the same. In some embodiments, the higher efficiency torque is increased from 5% to 25% in order to allow the use of the intermediate torque level. In some embodiments, the higher efficiency torque is increased from 10% to 25% in order to allow the use of the intermediate torque level range. In some embodiments, the intermediate torque level range is at an efficiency of between about 70% to 80%, as shown in FIG. 1. In some embodiments, the intermediate torque level is at an efficiency of less than 90%, as shown in FIG. 1. In some embodiments, instead of a zero level torque, a torque that is less than an intermediate torque and greater than zero may be used.

Many electric machines are designed to operate using alternating current. For example, a three-phase AC induction motor may use three alternating signals that are 120° out of phase from each other. In an embodiment, the amplitude of each signal would be the current needed to provide the desired torque specified in FIGS. 2-4.

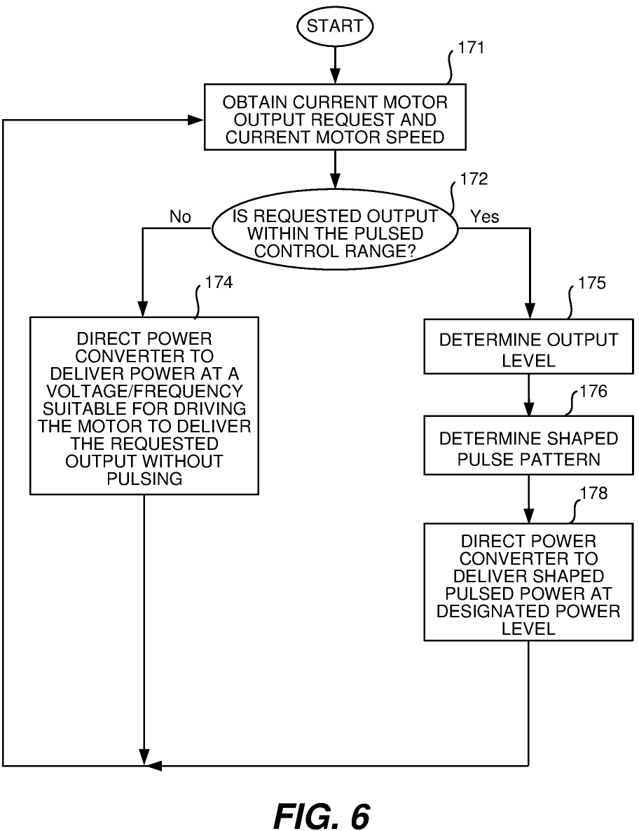

FIG. 5 is a block diagram illustrating a system having an electric machine controller 50 that enables the pulsed operation of an electric machine 52. The electric machine 52 may be any type of electric machine, including induction motors/machines, permanent magnet assisted synchronous reluctance machines, IPM machines, and others. The illustrated electric machine 52 is a three phase electric machine although it should be appreciated that the electric machine may be designed to utilize any desired number of phases including just a single phase.

The electric machine controller 50 includes a power converter 54, a pulse controller 30, and a torque control decision module 62. The power converter 54 may be operated as a power inverter or power rectifier depending on the direction of energy flow through the system.

When the electric machine 52 is operated as a motor, the power converter 54 is responsible for generating three phase AC power (denoted as 18A, 18B, and 18C for phases A, B, and C respectively) from the DC power supply/sink 56. Three-phase AC power in this example is provided by three power signals with the same amplitude and frequency, but 120° out of phase from each other. The three-phased input power is applied to the windings of the stator of the electric machine 52 for generating a Rotating Magnetic Force (RMF). In an induction motor, this rotation field induces current to flow in the rotor winding which in turn induces a rotor magnetic field. The interaction of the rotor and stator magnetic fields generates an electromagnetic force (EMF) causing rotation of the rotor, which in turn rotates a motor shaft. The rotating shaft provides the output torque of the motor. For most common permanent magnetic motors, the rotor field is that of the permanent magnet.

The three phases, 18A-18C are each depicted by lines with arrows on both ends indicating that current can flow in either direction. When used as a motor, current flows from the power supply/sink 56, through the power converter 54, to the electric machine 52. When used as a generator, the current flows from the electric machine 52, through the power converter 54, to the power supply/sink 56. When operating as a generator, the power converter 54 essentially operates as a power rectifier, and the AC power coming from the electric machine 52 is converted to DC power being stored in the DC power supply, such as a battery or capacitor.

The pulse controller 30 is responsible for selectively pulsing the three-phased input current 18A-18C to the electric machine 52. During conventional (i.e., continuous) operation, the three-phased input current provided to the electric machine 52 are continuous sinusoidal current signals, each 120° degrees out of phase with respect to one another. In this example, when the electric machine 52 is in sync with the three-phase AC power, the frequency of each signal of the three-phase AC power is equal to the frequency of rotation of the motor shaft and the amplitude of the signals of the three-phase AC power is related to the torque provided by the motor shaft.

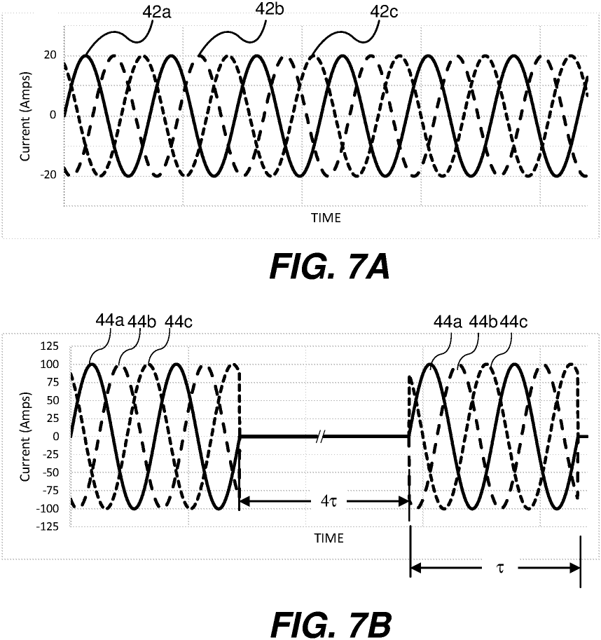

FIG. 6 illustrates a control flow that may be performed by pulse controller 30 to cause the electric machine 52 to efficiently deliver a desired electric machine output as a torque demand. To simplify the discussion, an embodiment in which the electric machine 52 functions as a motor is described. In this arrangement, the power supply/sink 56 acts as a power supply, and the pulse controller 30 functions as a motor controller.

Initially, the pulse controller 30 determines an output demand (torque demand) and any required motor state information such as the current motor speed as represented by block 171. The pulse controller 30 then determines whether the requested desired electric machine output (torque demand) is within the pulse control range as represented by decision block 172. This decision can be made in any desired manner. By way of example, in some embodiments, a look-up table or other suitable data structure can be used to determine whether pulsed control is appropriate. In some implementations, a simple lookup table may identify a maximum efficiency torque level at which pulsed control is appropriate for various motor speeds. The maximum efficiency torque level may be the energy conversion efficient output level. In an embodiment, the maximum efficiency torque level may be a designated output level. In such an implementation, the current motor speed may be used as an index to the lookup table to obtain a maximum efficiency torque level at which the pulsed control is appropriate under the current operating conditions. The designated output level can then be compared to the requested torque to determine whether the requested output is within the pulse control range.

If the requested torque/current operating conditions are outside of the pulsed control range for any reason, then traditional (i.e., continuous/non-pulsed output) motor control is used as represented by the “no” branch flowing from decision block 172. As such, pulsing is not used and the power converter 54 is directed to deliver power to the electric machine 52 at a level suitable for driving the motor to deliver the requested output in a conventional manner as represented by block 174. Conversely, when the requested torque/current operating conditions are within the pulsed control range, then pulsed control is utilized as represented by the “yes” branch flowing from block 172. In such embodiments, the pulse controller 30 will direct the power converter 54 to deliver power to the motor using a shaped pulse pattern. The shaped pulse pattern provides power at a first torque level, a second torque level, and an intermediate torque level range.

To facilitate pulsed operation, the pulse controller 30 determines the desired output level (block 175). A shaped pulse pattern is determined (block 176) dependent on the current motor speed and desired output level. The pulse controller 30 then directs the power converter 54 to implement the desired shaped pulse pattern at the designated power level (block 178). Conceptually, this may be accomplished by modulating the amplitude of the AC power signals.

The pulse controller 30 preferably determines the shape and frequency of the shaped pulse pattern. In some embodiments, the pulsing frequency can be fixed for all operating conditions of the motor, while in others it may vary based on operational conditions such as motor speed, torque requirements, etc. For example, in some embodiments, the shaped pulse pattern and frequency can be determined through the use of a look-up table. In such embodiments, the appropriate shaped pulse pattern and frequency for current motor operating conditions can be looked up using appropriate indices such as motor speed, torque requirement, etc. In other embodiments, the shaped pulse pattern and frequency are not necessarily fixed for any given operating conditions and may vary as dictated by the pulse controller 30. This type of variation is common when using sigma delta conversion in the determination of the pulses.

Although FIG. 6 illustrates some of the steps sequentially to facilitate a clear understanding of the functionality provided, it should be understood that many of the steps can be combined and/or reordered in practice. For example, the entries in a multi-dimensional lookup table that uses requested output and current electric motor speed as indices may indicate both the preferred output level and the duty cycle that is appropriate for the current operation.

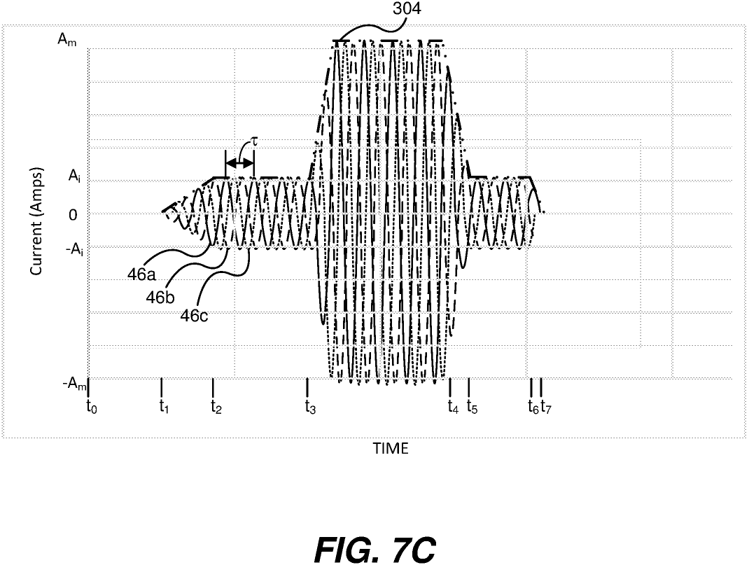

FIG. 7A illustrates conventional sinusoidal three-phased current 42a, 42b, and 42c delivered to/produced by the electric machine 52 during excitation. Phase B, denoted by curve 42b, lags phase A, denoted by 42a, by 120 degrees. Phase C, denoted by curve 42c, lags phase B by 120 degrees. The three-phased current 42a, 42b, and 42c is continuous (not pulsed) and has a designated amplitude of approximately 20 amps. It should be appreciated that 20 amps is only a representative current amplitude, and the current amplitude may have any value. In an example, a first phase current 42a may provide the first sinusoidal current signal 18A, the second phase current 42b may provide the second sinusoidal current signal 18B, and the third phase current 42c may provide the third sinusoidal current signal 18C.

FIG. 7B illustrates an example of pulsed three-phased sinusoidal current waveforms 44a, 44b, and 44c. In this example, the width of the time that a pulse of power is provided is designated as τ. The amount of time that the power is off between pulses is shown to be 4τ (four times τ). A broken line is shown to indicate that the entire time that the power is off is not shown in order to fit the figure on the page. As a result, each set of waveforms has a twenty percent (20%) duty cycle and peak amplitude of approximately 100 amps. Such a pulsed waveform could be used to provide the torque pulse pattern 204 shown in FIG. 2. In an example, the pulse pattern provides the same average output torque as the continuous wave pattern shown in FIG. 7A.

FIG. 7C illustrates an example of pulsed three-phased sinusoidal current waveforms 46a, 46b, and 46c that could be used to provide the shaped pulse pattern 304, shown in FIG. 3. In this embodiment, from time t₀ to t₁, the pulsed three-phased sinusoidal current waveforms 46a, 46b, and 46c have an amplitude of zero amps in order to provide zero torque level to the motor. From time t₁ to t₂, the amplitude of the pulsed three-phased sinusoidal current waveforms 46a, 46b, and 46c is ramped up to an intermediate current level Aᵢ, so that the torque level is ramped from zero to an intermediate power or torque level value Tᵢ (See FIG. 3). From time t₂ to t₃, pulsed three-phased sinusoidal current waveforms 46a, 46b, and 46c have an amplitude of Aᵢ, so that the torque level is held at the intermediate torque level Tᵢ, providing an intermediate torque level step that lasts for a first plurality of AC cycles or periods τ. From time t₃ to t₄, the amplitude of the pulsed three-phased sinusoidal current waveforms 46a, 46b, and 46c is ramped up to and held at a higher efficiency current level Aₘ, so that the torque is ramped to and held at a higher efficiency torque level Tₑ (See FIG. 3), providing the higher efficiency torque level step that lasts for a second plurality of AC cycles or periods. From time t₄ to t₅, the amplitude of the pulsed three-phased sinusoidal current waveforms 46a, 46b, and 46c is ramped down to the intermediate current level Aᵢ, so that the torque level is ramped down to the intermediate torque level Tᵢ. From time t₅ to t₆, the amplitude of the pulsed three-phased sinusoidal current waveforms 46a, 46b, and 46c is held at the intermediate current level Aᵢ, so that the torque level is held at the intermediate torque level Tᵢ, providing a second intermediate torque level step that lasts for a third plurality of AC cycles or periods τ. From time t₆ to t₇, the amplitude of the pulsed three-phased sinusoidal current waveforms 46a, 46b, and 46c is ramped down to zero, so that the torque level is ramped down to zero, providing another zero torque level step that lasts for a fourth plurality of AC cycles or periods. The shaped pulse pattern 304 is completed.

During pulsed operation, the phased three sinusoidal current signals 18A-18C are selectively pulsed. In the pulsed operation, the amplitude of the signals of the three-phase AC power changes between a first amplitude corresponding to the first torque level, a second amplitude corresponding to the second torque level, and an intermediate amplitude range corresponding to the intermediate torque level range. In an example, at a constant speed, in pulsed operation, the frequency of the AC power signals does not change, while the frequency of a shaped pulse pattern may change.

In some embodiments, a value stored in the lookup table (such as a duty cycle of 1 (100%) or other suitable wildcards) can optionally be used to indicate that pulsing is not desired. Of course, a wide variety of other conventions and data structures can be used to provide the same information.

In some embodiments, the pulse control table can be incorporated into a larger table that defines operation at all levels such that the operational flow is the same regardless of whether conventional or pulse control is desired with the conventional control merely being defined by a duty cycle of 1 and the appropriate motor input power level, and the pulse control being defined by specified shaped pulse patterns.

In some embodiments, it may be desirable to avoid the use of pulsing in some operating regions even when efficiency improvements are possible, based on other considerations. These other considerations may be based on factors such as noise and vibration, the practical switching capabilities of the controller, etc. Regardless of the nature of the pulsing that is used, the torque modulation is preferably managed in a manner such that NVH that is unacceptable for the intended application is not produced.

The pulse controller described herein may be implemented in a wide variety of different manners including using software or firmware executed on a processing unit such as a microprocessor, using programmable logic, using application specific integrated circuits (ASICs), using discrete logic, etc., and/or using any combination of the foregoing.

The energy conversion efficiency of power converters will also typically vary over the operating range of the power converter. In some embodiments, when optimizing the control of a generator that is part of a rectifier/generator system, it is desirable to consider the energy conversion efficiency of the overall rectifier/generator system as opposed to the energy conversion efficiency of the generator alone.

Preferably, the pulse control of the shaped pulse of an electric machine will be modeled to account for the efficiencies of any/all of the components that influence the energy conversion during pulsing. For example, when power for an AC electric motor is drawn from a battery, the battery’s power delivery efficiency, cabling losses between components, and any other loss factors can be considered in addition to the converter and motor efficiencies, when determining the motor drive signal that delivers the best energy conversion efficiency.

In general, the overall energy conversion efficiency of a power converter/electric machine system is a function of the product of the converter conversion efficiency times the electric machine conversion efficiency times the delivery efficiency of other components. Thus, it should be appreciated that the parameters of the shaped pulsed drive signal that has the maximum system energy conversion efficiency may be different than the parameters that would provide the best energy conversion efficiency for the motor itself.

### Pulse Generation

As suggested above, once the desired shaped pulse pattern is determined, the shaped pulse pattern used to drive the motor can be generated in a wide variety of manners. One relatively simple approach is to use the pulse controller 30 to provide the shaped pulse.

In various embodiments, the shaped pulse may be used in different types of motor control, including AC electric motor control and DC brushless motor control. When an AC induction motor is powered by a battery (which provides DC power), a power converter, such as an inverter, may be used to facilitate the conversion of DC power to AC power. In such an embodiment, the amplitude of the AC signal that is generated by the converter may be used to provide the shaped pulse.

In some embodiments, a sigma delta based pulse controller may be used to control the timing of the pulses. As will be appreciated by those familiar with sigma delta control, a characteristic of sigma delta control is that it facilitates noise shaping and tends to reduce/eliminate idle tones and push noise to higher frequencies. When noise is randomized and/or spread to frequencies that are above the limits of human perception, it is less of a concern since any such noise and/or vibration is not bothersome to the users of the motor. Therefore, in the context of an automotive electric motor application, the use of sigma delta control tends to reduce the likelihood of vehicle occupants perceiving noise or vibrations due to the pulsed motor control. Various embodiments may be combined with sigma delta control to further reduce NVH. U.S. Pat. No. 10,742,155, which is incorporated herein by reference in its entirety, describes a number of representative sigma delta converter designs.

### Motor Types and Applications

It should be apparent from the foregoing description that the described pulsed machine control can be utilized in a wide variety of different applications to improve the energy conversion efficiency of a wide variety of different types of electric motors and generators. These include both AC and DC motors/generators.

A few representative types of electric machines that may benefit from the described pulsing include both asynchronous and synchronous AC electric machines including: Induction machines (IM); switched reluctance machines (SMR); Synchronous Reluctance machines (SynRM); Permanent Magnet Synchronous Reluctance machines (PMaSynRM); Hybrid PMaSynRMs; Externally Excited AC Synchronous machines (SyncAC or EESM); Wound Field Synchronous machines (WFSM), Wound Rotor Synchronous Machine (WRSM), Permanent Magnet Synchronous machines (PMSM); Eddy current machines; AC linear machines; AC and DC mechanically commutated machines; axial flux motors; etc. Representative DC electric machines include brushless, electrically excited, permanent magnet, series wound, shunt, brushed, compound, and others. In some embodiments, the electric machine may be a hybrid permanent magnet synchronous reluctance machine.

Although only a few embodiments of the invention have been described in detail, it should be appreciated that the invention may be implemented in many other forms without departing from the spirit or scope of the invention. The variously described pulse controllers and other control elements may be implemented, grouped, and configured in a wide variety of different architectures in different embodiments. For example, in some embodiments, the pulse controller may be incorporated into a motor controller or a converter controller or it may be provided as a separate component. Similarly, for a generator, the pulse controller may be incorporated into a generator controller or a rectifier controller and in combined motor/generators the pulse controller may be incorporated into a combined motor/generator controller or a combined converter/rectifier controller. In some embodiments, the described control functionality may be implemented algorithmically in software or firmware executed on a processor – which may take any suitable form, including, for example, general purpose processors and microprocessors, DSPs, etc.

The pulse controller may be part of a larger control system. For example, in vehicular applications, the described control may be part of a vehicle controller, a powertrain controller, a hybrid powertrain controller, or an ECU (engine control unit), etc. that performs a variety of functions related to vehicle control. In such applications, the vehicle or other relevant controller, etc. may take the form of a single processor that executes all of the required control, or it may include multiple processors that are co-located as part of a powertrain or vehicle control module or that are distributed at various locations within the vehicle. The specific functionalities performed by any one of the processors or control units may be widely varied.

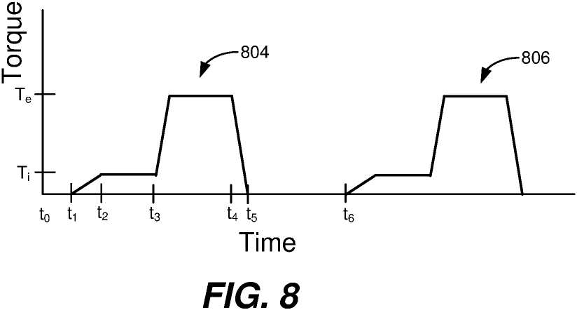

FIG. 8 illustrates an example of another shaped pulse pattern used in another embodiment. In this embodiment, from time t₀ to t₁, zero torque level pulses are applied to the motor. In this example, the zero torque level pulses provide no power or pulses. A shaped pulse pattern 804 is then applied. In the torque pattern from time t₁ to t₂, the torque level is ramped from zero to an intermediate power or torque level range value Tᵢ. From time t₂ to t₃, the torque level held at the intermediate torque level range value Tᵢ, providing a first intermediate torque level range. From time t₃ to t₄, the torque is ramped to and held at a higher efficiency torque level Tₑ, providing a higher efficiency torque level step. From time t₄ to t₅, the torque level is ramped down to the zero torque level. The zero torque level is maintained until t₆ when a new shaped pulse pattern 806 begins. By providing the shaped pulse pattern 804 where the intermediate torque level range is provided before the higher efficiency torque level, but not after the higher efficiency torque level the shaped pulse pattern 804 may be more energy efficient than shaped pulse pattern 304 (See FIG. 3), where an intermediate torque level range is provided both before and after the higher efficiency torque. However, shaped pulse pattern 304 may have reduced NVH compared to shaped pulse pattern 804. The main goal in some embodiments is to reduce NVH. However, if shaped pulse pattern 804 provides a satisfactorily reduced NVH, then the efficiency provided by shaped pulse pattern 804 would be beneficial.

In some embodiments, a shaped pulse pattern may have a first intermediate torque level range and a second intermediate torque level range that is different from the first intermediate torque level range, where the first intermediate torque level range and the second intermediate torque level range are between the first torque level and the second torque level. In some embodiments, the first intermediate torque level range has an average first intermediate torque level and the second intermediate torque level range has an average second intermediate torque level, where the average first intermediate torque level is different from the average second intermediate torque level. A shaped pulse pattern would comprise a first torque level step, a second torque level step, a first intermediate torque level step, and a second intermediate torque level step. The different torque level steps may be in various orders. The different torque level steps would have the same frequency and would be out of phase from each other. Various embodiments may have a shaped pulse pattern with additional intermediate torque level steps. In various embodiments, the widths of the intermediate torque level steps may be increased or decreased to balance the improvement of efficiency and the reduction of NVH to provide an acceptable NVH. In addition, the number of different intermediate torque level steps are chosen to improve efficiency while reducing NVH. In some embodiments, the timing of the torque pulse patterns may be timed according to a position of a stator of the electric machine.

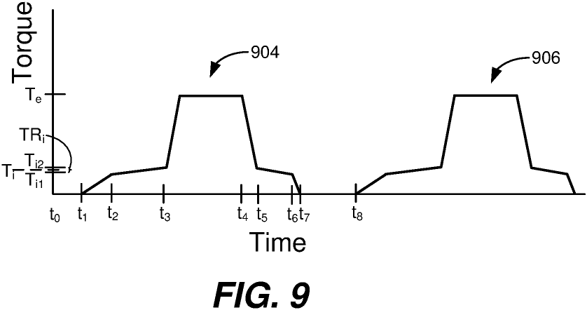

FIG. 9 illustrates another example of a shaped pulse pattern 904 used in an embodiment. In this embodiment, from time t₀ to t₁, zero torque level pulses are applied to the motor. In this example, the zero torque level pulses provide no power or pulses. A shaped pulse pattern 904 is then applied. In the torque pattern from time t₁ to t₂, the torque level is ramped from zero to an intermediate power or torque level Tᵢ₁. From time t₂ to t₃, the torque or power is held within an intermediate torque level range TRi, providing a first intermediate torque level range. In some embodiments, the intermediate torque or power level range TRᵢ is a range from Tᵢ₁ to Tᵢ₂ over a time period from t₂ to t₃ with an average intermediate torque level value of Tᵢ. From time t₃ to t₄, the torque is ramped to and held at a higher efficiency torque level Tₑ, providing a higher efficiency torque level step. From time t₄ to t₅, the torque level is ramped down to an intermediate torque level Tᵢ₂. From time t₅ to t₆, the torque or power is level held at the intermediate torque level range TRi, providing a second intermediate torque level range. In some embodiments, the intermediate torque or power level range TRᵢ is a range from Tᵢ₁ to Tᵢ₂ over a time period from t₅ to t₆. From time t₆ to t₇, the torque level is ramped down to zero. The shaped pulse pattern 904 is completed. From time t₇ to t₈, the torque level is kept at zero, providing a zero torque level step. A new shaped pulse pattern 906 begins at time t₈. In this embodiment for a given desired torque output, the shaped pulse pattern 904 and the new shaped pulse pattern 906 have the same shape and provide a set duty cycle.

By providing an intermediate torque level range instead of a single intermediate torque level, reduced constraints are allowed. It will require fewer parameters to create the shaped pulse pattern using software which can be done just by adjusting the ramp rate along ramp-up and ramp-down. It will allow a smoother transition of radial and tangential force changes during the pulsed operation of the motor. It may reduce the time at zero torque level which can further improve efficiency during pulsed operation. However, the key advantage again will be the reduced vibration in the application under the pulsed operation of the motor.

In some embodiments, the intermediate torque levels are either ramped up or ramped down, either strictly increasing or strictly decreasing. In some embodiments, the slope of the ramping or the range of TRᵢ and period of the intermediate torque or power level is limited so that the

$$\left|\left({T}_{i 1} - {T}_{i 2}\right) / \left({t}_{2} - {t}_{3}\right)\right| \leq 25 \frac{N m}{m i l l i s e c o n d} .$$

In some embodiments, the range of TRᵢ is further constrained so that

$$\left|\left({T}_{i 1} - {T}_{i 2}\right)\right| < 5 N m ,$$

so that the range of TRᵢ is less than 5 Nm. In some embodiments, the intermediate torque levels do not provide a slope but may provide a curve where the range of TRᵢ and the time period meet the requirements of Equations 1 and 2, and where Tᵢ₁ and Tᵢ₂ are the minimum and maximum torques provided during the time period between t₂ and t₃. In some embodiments, the time period between t₂ and t₃ is between 0.2 milliseconds and 3 milliseconds. In some embodiments, the time period between t₂ and t₃ is at least 1 millisecond. In some embodiments, the range of TRᵢ is constrained so that | (Tᵢ₁ - Tᵢ₂)| < 1 Nm, so that the range of TRᵢ is less than 1 Nm.

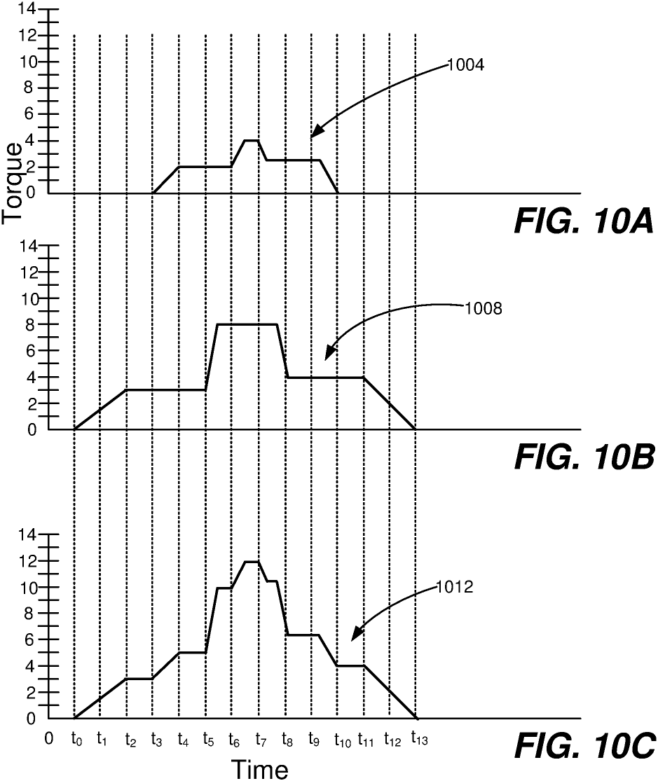

FIGS. 10A-10C illustrate another example of a shaped pulse pattern used in some embodiments. FIG. 10A illustrates a first shaped pulse pattern 1004. The first shaped pulse pattern 1004 provides an initial zero torque until time t₃. From t₃ to t₄ the first shaped pulse pattern 1004 is ramped up to a first intermediate torque of 2. From t₆ to a time between t₆ and t₇ the first shaped pulse pattern 1004 is ramped to a maximum first shaped pulse pattern torque of 4. From t₇ to a time between t₇ and t₈, the first shaped pulse pattern 1004 is ramped down to a second intermediate torque of about 2.5. From a time between t₉ and t₁₀ to t₁₀, the first shaped pulse pattern 1004 is then ramped down to a torque of zero. The first shaped pulse pattern 1004 is then repeated. The first shaped pulse pattern 1004 provides an example where the first intermediate torque is different than the second intermediate torque.

FIG. 10B illustrates a second shaped pulse pattern 1008. The second shaped pulse pattern 1008 provides an initial zero torque until time t₀. From t₀ to t₂ the second shaped pulse pattern 1008 is ramped up to a first intermediate torque of 3. From t₅ to a time between t₅ and t₆ the second shaped pulse pattern 1008 is ramped to a maximum second shaped pulse pattern torque of 8. From a time between t₇ and t₈ to t₈, the second shaped pulse pattern 1008 is ramped down to a second intermediate torque of 4. From a time between t₁₁ to t₁₃, the second shaped pulse pattern 1008 is then ramped down to a torque of zero. The second shaped pulse pattern 1008 is then repeated with the same frequency as the first shaped pulse pattern 1008. The second shaped pulse pattern 1008 provides another example where the first intermediate torque is different than the second intermediate torque.

FIG. 10C illustrates a summed (or compound) shaped pulse pattern 1012. The summed shaped pulse pattern 1012 is the sum of the first shaped pulse pattern 1004 and the second shaped pulse pattern 1008. The summed shaped pulse pattern 1012 provides an initial zero torque until time t₀. From t₀ to t₂ the summed shaped pulse pattern 1012 is ramped up to a first intermediate torque of 3 due to the ramping of the second shaped pulse pattern 1008. The first intermediate torque is provided from t₂ to t₃. From t₃ to t₄ the summed shaped pulse pattern 1012 is ramped again due to the ramping provided by the first shaped pulse pattern 1004. The summed shaped pulse pattern 112 is ramped to a second intermediate torque of 5, which is the sum of the first intermediate torque of 2 from the first shaped pulse pattern 1004 and the first intermediate torque of 3 from the second shaped pulse pattern 1008. From t₅ to a time between t₅ and t₆, the summed shaped pulse pattern 1012 is again ramped, due to the ramping of the second shaped pulse pattern 1008, so that the summed shaped pulse pattern reaches a third intermediate torque of 10, which is the sum of the first intermediate torque of 2 of the first shaped pulse pattern 1004 and the maximum torque of 8 of the second shaped pulse pattern 1008. From t₆ to a time between t₆ and t₇ the summed shaped pulse pattern 1012 is ramped to a maximum torque of 12, which is the sum of the maximum torque of 4 of the first shaped pulse pattern 1004 and the maximum torque of 8 of the second shaped pulse pattern 1008.

From t₇ to a time between t₇ and t₈, the summed shaped pulse pattern 1012 is ramped down to a fourth intermediate torque of about 10.5, which is the sum of the second intermediate torque of about 2.5 of the first shaped pulse pattern 1004 and the maximum value of 8 of the second shaped pulse pattern 1008, where the ramping is caused by the ramping down of the first shaped pulse pattern 1004. From a time between t₇ and t₈ to t₈, the summed shaped pulse pattern 1012 is ramped down to a fifth intermediate torque of 6.5, which is the sum of the second intermediate torque of 2.5 of the first shaped pulse pattern 1004 and the second intermediate torque of 4 of the second shaped pulse pattern 1008, where the ramp down is caused by the ramp down of the second shaped pulse pattern 1008. From a time between t₉ and t₁₀ to t₁₀, the summed shaped pulse pattern 1012 is then ramped down to a sixth intermediate torque of 4 from the torque of the second shaped pulse pattern 1008, where the ramping down is caused by the ramping down of the first pulse pattern 1004. From a time between t₁₁ to t₁₃, the summed shaped pulse pattern 1012 is then ramped down to a torque of zero, where the ramping is caused by the ramping of the second shaped pulse pattern 1008. The summed shaped pulse pattern 1012 is then repeated with the same frequency as the first shaped pulse pattern 1004 and the second shaped pulse pattern 1012. The summed shaped pulse pattern provides another example of different intermediate torques.

The summed shaped pulse is a complex shaped pulse that is formed by the sum of two or more simpler shaped pulses. At the higher torque levels, the slope of the ramp of torque versus time is steeper than at lower torque levels. The reason for the steeper slope is caused because, at higher torques and higher currents, the magnetic core materials are more saturated, allowing for a faster increase or decrease in torque with respect to time. In some embodiments, the first intermediate torque is a first, second, third, fourth, fifth, and sixth intermediate torques may be first, second, third, fourth, fifth, and sixth intermediate torque ranges.

In some embodiments, the electric motor will be controlled by the shaped pulse patterns shown in FIG. 9 which has zero torque levels from t0 to t1 and from t7 to t8. In some embodiments, the motor will be controlled using the discontinuous pulse width modulation (DPWM) technique during the zero torque level portion of the pulse. In some embodiments, the motor will be controlled using the discontinuous pulse width modulation (DPWM) technique during the intermediate torque level portion.

While this disclosure has been described in terms of several preferred embodiments, there are alterations, modifications, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, modifications, permutations, and various substitute equivalents as fall within the true spirit and scope of the present disclosure.

What is claimed is:

1. An electric machine controller arranged to direct a power converter to cause pulsed operation of an electric machine in selected operational ranges to deliver a desired output, wherein a pulsed operation of the electric machine causes an output of the electric machine to provide a shaped pulse pattern that alternates between a first torque level, a second torque level, and an intermediate torque level range, wherein the second torque level is lower than the first torque level, wherein the intermediate torque level range is between the first torque level and the second torque level, wherein the first torque level, second torque level, and intermediate torque level range and shaped pulse pattern are selected to provide an overall average system output having a higher energy conversion efficiency during the pulsed operation of the electric machine than the electric machine would have when operated at a third torque level that would be required to drive the electric machine in a continuous manner to deliver the same overall average system output, wherein the intermediate torque level range is a range of less than 5 Nm and wherein the intermediate torque level range is provided for at least 1 millisecond.

2. The electric machine controller, as recited in claim 1, wherein the second torque level is substantially zero torque.

3. The electric machine controller, as recited in claim 2, wherein the electric machine is controlled using a discontinuous pulse width modulation (DPWM) technique during the second torque level.

4. The electric machine controller, as recited in claim 2, wherein the intermediate torque level range has an average intermediate torque level that is no more than 25% of the first torque level.

5. The electric machine controller, as recited in claim 4, wherein the electric machine is controlled using discontinuous pulse width modulation (DPWM) technique during the second torque level and intermediate torque level range.

6. The electric machine controller, as recited in claim 1, wherein the electric machine controller includes a pulse controller that provides a pulse pattern of the electric machine, wherein the pulse pattern provides the shaped pulse pattern comprising the first torque level for a first period of time, the second torque level for a second period of time, and the intermediate torque level range for a third period of time.

7. The electric machine controller, as recited in claim 6, wherein the first period of time and the second period of time and the third period of time are equal.

8. The electric machine controller, as recited in claim 6, further comprising providing the intermediate torque level range for a fourth period of time, wherein in the shaped pulse pattern, the third period of time is before the first period of time and the fourth period of time is after the first period of time.

9. The electric machine controller, as recited in claim 6, wherein in the shaped pulse pattern, the third period of time is before the first period of time and wherein each shaped pulse pattern has only one period of time at the intermediate torque level range.

10. The electric machine controller, as recited in claim 1, wherein the electric machine controller includes a pulse controller that provides a pulse pattern of the electric machine, wherein the pulse pattern provides the shaped pulse pattern comprising at least one first torque level step, at least one second torque level step, and at least one intermediate torque level range step.

11. The electric machine controller, as recited in claim 10, wherein the pulse controller that provides the pulse pattern that provides a first plurality of cycles of an AC power at a first amplitude to provide the first torque level step and provides a second plurality of cycles of an AC power at a second amplitude to provide the second torque level and provides a third plurality of cycles of an AC power at an intermediate amplitude range to provide the intermediate torque level range.

12. A system comprising:
an electric machine;
a power converter; and
the electric machine controller as recited in claim 1.

13. The system, as recited in claim 12, wherein the electric machine is a motor, and the power converter includes an inverter.

14. The system, as recited in claim 12, wherein the electric machine is a generator, and the power converter includes a rectifier.

15. The system, as recited in claim 12, wherein the electric machine is configured to operate as a motor/generator.

16. The system, as recited in claim 12, wherein the electric machine is an induction machine that has at least three phases.

17. The system, as recited in claim 12, wherein the electric machine is a synchronous AC electric machine.

18. The system, as recited in claim 17, wherein the electric machine is selected from the group consisting of:
a synchronous reluctance machine,
a permanent magnet assisted synchronous reluctance machine;
a hybrid permanent magnet synchronous reluctance machine;
an externally excited AC synchronous machine; and
a permanent magnet synchronous machine.

19. The electric machine controller, as recited in claim 1, wherein the electric machine controller includes a pulse controller that provides a pulse pattern of the electric machine, wherein the pulse pattern provides the shaped pulse pattern comprising a first torque level step, at least one second torque level step, and an intermediate torque level step, wherein the shaped pulse pattern has only one first torque level step and only one intermediate torque level step.

20. The electric machine controller, as recited in claim 1, wherein the electric machine controller includes a pulse controller that provides a pulse pattern of the electric machine, wherein the pulse pattern provides the shaped pulse pattern comprising a first torque level step, at least one second torque level step, and an intermediate torque level step, wherein the shaped pulse pattern has only one first torque level step and has two intermediate torque level steps, wherein the two intermediate torque level steps are a first intermediate torque level step and a second intermediate torque level step.

21. The electric machine controller, as recited in claim 20, wherein the first intermediate torque level step lasts a first period of time and the second intermediate torque level step lasts a second period of time, wherein the first period of time equals the second period of time.

22. The electric machine controller, as recited in claim 20, wherein the first intermediate torque level step lasts a first period of time and the second intermediate torque level step lasts a second period of time, wherein the first period of time is not equal to the second period of time.

23. The electric machine controller, as recited in claim 1, wherein the shaped pulse pattern further comprises a second intermediate torque level range, wherein the second intermediate torque level range is between the first torque level and the second torque level and is different from the intermediate torque level range and wherein the second intermediate torque level range is a range of less than 5 Nm and wherein the second intermediate torque level range is provided for at least 1 millisecond.

24. The electric machine controller, as recited in claim 23, wherein the shaped pulse pattern further comprises a third intermediate torque level range, a fourth intermediate torque level range, a fifth intermediate torque level range, and a sixth intermediate torque level range between the first torque level and the second torque level and wherein the third, fourth fifth, and sixth intermediate torque level ranges are ranges of less than 5 Nm provided for at least 0.2 milliseconds.

25. A method for controlling an electric machine by an electric machine controller arranged to direct a power converter, the method comprising directing a pulsed operation of the electric machine in selected operational ranges to deliver a desired output, wherein a pulsed operation of the electric machine provides a shaped pulse pattern, wherein the shaped pulse pattern alternates between a first torque level, a second torque level, and an intermediate torque level range, wherein the second torque level is lower than the first torque level, wherein the intermediate torque level range is between the first torque level and the second torque level, and wherein the first torque level, second torque level, and intermediate torque level range, and shaped pulse pattern are selected to provide an overall average system output such that the electric machine has a higher energy conversion efficiency during the pulsed operation of the electric machine than the electric machine would have when operated at a third torque level that would be required to drive the electric machine in a continuous manner to deliver the overall average system output, wherein the intermediate torque level range is a range of less than 5 Nm and wherein the intermediate torque level range is provided for at least 1 millisecond.

26. The method, as recited in claim 25, wherein the second torque level is substantially zero torque.

27. The method, as recited in claim 25, wherein the intermediate torque level range has an average intermediate torque level that is no more than 25% of the first torque level.

28. The method, as recited in claim 25, wherein the shaped pulse pattern provides the first torque level for a first period of time, the second torque level for a second period of time, and the intermediate torque level range for a third period of time.

29. The method, as recited in claim 25, wherein the shaped pulse pattern comprises at least one first torque level step, at least one second torque level step, and at least one intermediate torque level step.

30. The method, as recited in claim 29, wherein the shaped pulse pattern provides a first plurality of cycles of an AC power at a first amplitude to provide the first torque level step and provides a second plurality of cycles of an AC power at a second amplitude to provide the second torque level and provides a third plurality of cycles of an AC power at an intermediate amplitude range to provide the intermediate torque level range.

31. The method, as recited in claim 25, further comprising:
determining whether a desired electric machine output is less than a designated output level that is an energy conversion efficient output level;
driving the electric machine with the pulsed operation to cause the electric machine to deliver the desired output when the desired electric machine output is less than the designated output level; and
driving the electric machine to deliver the desired electric machine output when the desired electric machine output is not less than the designated output level.

32. The method, as recited in claim 31, wherein the driving the electric machine to deliver the desired electric machine output provides a continuous and non-pulsed output.

33. The method, as recited in claim 25, wherein the shaped pulse pattern, wherein the shaped pulse pattern has only one first torque level step and only one intermediate torque level step.

34. The method, as recited in claim 25, wherein the shaped pulse pattern has only one first torque level step and has two intermediate torque level steps, wherein the two intermediate torque level steps are a first intermediate torque level step and a second intermediate torque level step.

35. The method, as recited in claim 34, wherein the first intermediate torque level step lasts a first period of time and the second intermediate torque level step lasts a second period of time, wherein the first period of time equals the second period of time.

36. The method, as recited in claim 35, wherein the first intermediate torque level step lasts a first period of time and the second intermediate torque level step lasts a second period of time, wherein the first period of time is not equal to the second period of time.

37. The method, as recited in claim 25, wherein the shaped pulse pattern further comprises a second intermediate torque level range, wherein the second intermediate torque level range is between the first torque level and the second torque level and is different from the intermediate torque level range and wherein the second intermediate torque level range is a range of less than 5 Nm and wherein the second intermediate torque level range is provided for at least 1 millisecond.

38. The method, as recited in claim 37, wherein the shaped pulse pattern further comprises a third intermediate torque level range, a fourth intermediate torque level range, a fifth intermediate torque level range, and a sixth intermediate torque level range between the first torque level and the second torque level and wherein the third, fourth fifth, and sixth intermediate torque level ranges are ranges of less than 5 Nm provided for at least 0.2 milliseconds.

39. An electric machine controller arranged to direct a power converter to cause pulsed operation of an electric machine in selected operational ranges to deliver a desired output, wherein a pulsed operation of the electric machine causes an output of the electric machine to provide a pulse train pattern that alternates between a first torque level, a second torque level, and an intermediate torque level, wherein the second torque level is lower than the first torque level, wherein the intermediate torque level is between the first torque level and the second torque level, wherein the first, second, and intermediate torque levels and pulse train pattern are selected to provide an overall average system output having a higher energy conversion efficiency during the pulsed operation of the electric machine than the electric machine would have when operated at a third torque level that would be required to drive the electric machine in a continuous manner to deliver the same overall average system output.

40. The electric machine controller, as recited in claim 39, wherein the second torque level is substantially zero torque.

41. The electric machine controller, as recited in claim 40, wherein the intermediate torque level is no more than 25% of the first torque level.

42. The electric machine controller, as recited in claim 39, wherein the electric machine controller includes a pulse controller that provides a pulse pattern of the electric machine, wherein the pulse pattern provides the pulse train pattern comprising the first torque level pulse for a first period of time, the second torque level for a second period of time, the intermediate torque level pulse for a third period of time, and the second torque level for a fourth period of time wherein the second period of time is between the first period of time and the third period of time and the fourth period of time is after the third period of time.

43. A system comprising:
an electric machine;
a power converter; and
the electric machine controller as recited in claim 39.

44. A method for controlling an electric machine by an electric machine controller arranged to direct a power converter, the method comprising directing a pulsed operation of the electric machine in selected operational ranges to deliver a desired output, wherein a pulsed operation of the electric machine causes a pulse train pattern of the electric machine, wherein the pulse train pattern alternates between a first torque level, a second torque level, and an intermediate torque level, wherein the second torque level is lower than the first torque level, wherein the intermediate torque level is between the first torque level and the second torque level, wherein the first, second, and intermediate torque levels and pulse train pattern are selected to provide an overall average system output such that the electric machine has a higher energy conversion efficiency during the pulsed operation of the electric machine than the electric machine would have when operated at a third torque level that would be required to drive the electric machine in a continuous manner to deliver the overall average system output.

45. The method, as recited in claim 44, wherein the second torque level is substantially zero torque.

46. The method, as recited in claim 45, wherein the intermediate torque level is no more than 25% of the first torque level.

47. The method, as recited in claim 45, wherein the pulse train pattern provides the first torque level pulse for a first period of time, the second torque level for a second period of time, the intermediate torque level pulse for a third period of time, and the second torque level for a fourth period of time wherein the second period of time is between the first period of time and the third period of time and the fourth period of time is after the third period of time.

48. The method, as recited in claim 44, further comprising:
determining whether a desired electric machine output is less than a designated output level that is an energy conversion efficient output level;
driving the electric machine with the pulsed operation to cause the electric machine to deliver the desired output when the desired electric machine output is less than the designated output level; and
driving the electric machine to deliver the desired electric machine output when the desired electric machine output is not less than the designated output level.

49. The method, as recited in claim 48, wherein the driving the electric machine to deliver the desired electric machine output provides a continuous and non-pulsed output.

50. An electric machine controller arranged to direct a power converter to cause pulsed operation of an electric machine in selected operational ranges to deliver a desired output, wherein a pulsed operation of the electric machine causes an output of the electric machine to provide a shaped pulse pattern that alternates between a first torque level, a second torque level, and an intermediate torque level, wherein the second torque level is lower than the first torque level, wherein the intermediate torque level is between the first torque level and the second torque level, wherein the first torque level, second torque level, and intermediate torque level and shaped pulse pattern are selected to provide an overall average system output having a higher energy conversion efficiency during the pulsed operation of the electric machine than the electric machine would have when operated at a third torque level that would be required to drive the electric machine in a continuous manner to deliver the same overall average system output.

51. The electric machine controller, as recited in claim 50, wherein the second torque level is substantially zero torque.

52. The electric machine controller, as recited in claim 51, wherein the intermediate torque level is no more than 25% of the first torque level.

53. The electric machine controller, as recited in claim 50, wherein the electric machine controller includes a pulse controller that provides a pulse pattern of the electric machine, wherein the pulse pattern provides the shaped pulse pattern comprising the first torque level for a first period of time, the second torque level for a second period of time, and the intermediate torque level for a third period of time.

54. The electric machine controller, as recited in claim 50, wherein the shaped pulse pattern further comprises a second intermediate torque level, wherein the second intermediate torque level is between the first torque level and the second torque level and is different from the intermediate torque level and wherein the intermediate torque level and the second intermediate torque level are provided for at least 1 millisecond.

55. The electric machine controller, as recited in claim 50, wherein the shaped pulse pattern further comprises a third intermediate torque level, a fourth intermediate torque level, a fifth intermediate torque level, and a sixth intermediate torque level between the first torque level and the second torque level and wherein the third, fourth fifth, and sixth intermediate torque level ranges are provided for at least 0.2 milliseconds.
